(19) United States
(12) Patent Application Publication
(10) Pub. No.: US 2012/0168249 A1
(43) Pub. Date: Jul. 5, 2012

(54) HUNTING LADDER STAND HAVING AN ENCLOSED PLATFORM

(75) Inventors: Michael R. Furseth, Cumberland, WI (US); Scott R. Nickell, Cumberland, WI (US); Randy L. Schamberger, Cumberland, WI (US); Benjamin T. Nelson, Cumberland, WI (US)

(73) Assignee: ARDISAM, INC., Cumberland, WI (US)

(21) Appl. No.: 13/083,708

(22) Filed: Apr. 11, 2011

Related U.S. Application Data
(60) Provisional application No. 61/429,604, filed on Jan. 4, 2011.

(51) Int. Cl. A01M 31/02; B23P 11/00; E04G 5/14

(52) U.S. Cl. 182/113; 182/115; 29/428

(57) ABSTRACT

An elevated hunting stand includes a ladder assembly and a platform assembly. A pair of vertical uprights is connected to the platform at a front portion of the platform. A pair of vertical uprights is connected to the platform at a rear portion of the platform. A pair of horizontal stabilizer members is attached to the vertical uprights. A pair of enclosure gates is attached to the vertical uprights. The vertical uprights, the horizontal stabilizer member, and the pair of enclosure gates form an enclosure on the platform. The enclosure gates are movable from an open position to a closed position.

### RELATED APPLICATIONS

The present application claims the benefit of U.S. Provisional Application entitled Tree Stand, Ser. No. 61/429,604 filed Jan. 4, 2011, which is hereby incorporated by reference.

### BACKGROUND OF THE INVENTION

Hunting stands are well known for allowing hunters to hunt comfortably from an elevated position for an extended period of time. Hunting stands have two basic components: a platform portion for supporting the hunter in a standing position and a seat portion for supporting the hunter in a seated position.

Conventional ladder stands include a ladder section which is used to support the platform and seat. Ladder stands are installed by attaching the platform and seat to the ladder section and simply leaning the ladder section against the tree and securing the ladder stand. Once a ladder stand is installed a user can freely enter or exit the stand by climbing the ladder section. Aside from the ease which ladder stands can be entered or exited, ladder stands offer several other significant advantages over hang-on and climbing stands, such as the ability to support larger platforms and seats which can allow for multiple hunters to be able to use the stand simultaneously. U.S. Pat. No. 4,742,888 discloses a conventional ladder stand.

Some conventional ladder stands include an enclosure and a blind to conceal a hunter's presence, such as the Spinshot™ model sold by River's Edge Treestands. A hunter enters and exits a blind enclosure by unzipping an opening in a blind. Having a zippered opening does not provide for maximum ease of entry into hunting stand.

### BRIEF SUMMARY OF THE INVENTION

The present disclosure is directed to embodiments of an elevated hunting stand providing an enclosed platform assembly and a seat assembly.

### BRIEF DESCRIPTION OF THE SEVERAL VIEWS OF THE DRAWING

The accompanying drawings, which are incorporated in and form a part of the specification, illustrate an exemplary embodiment of the present disclosure and, together with the description, serve to explain the principles of the disclosure. In the drawings:

FIG. 1 is a perspective view of an exemplary hunting stand with an enclosed platform in accordance with an embodiment of the present disclosure.

FIG. 2 is an enlarged perspective view of the enclosed platform shown in FIG. 1.

FIG. 3 illustrates an enlarged perspective view of an exemplary seat assembly in accordance with an embodiment of the present disclosure.

FIG. 4 illustrates an enclosed platform gate in accordance with an embodiment of the present disclosure.

FIG. 5A illustrates an exemplary gate bracket connected to an upper portion of an enclosed platform gate in accordance with an embodiment of the present disclosure.

FIG. 5B illustrates an exemplary gate bracket connected to a lower portion of an enclosed platform gate in accordance with an embodiment of the present disclosure.

FIG. 6A illustrates a front view of an exemplary gate bracket in accordance with an embodiment of the present disclosure.

FIG. 6B illustrates a top view of an exemplary gate bracket in accordance with an embodiment of the present disclosure.

FIG. 6C illustrates a side view of an exemplary gate bracket in accordance with an embodiment of the present disclosure.

### DETAILED DESCRIPTION OF PREFERRED EMBODIMENTS

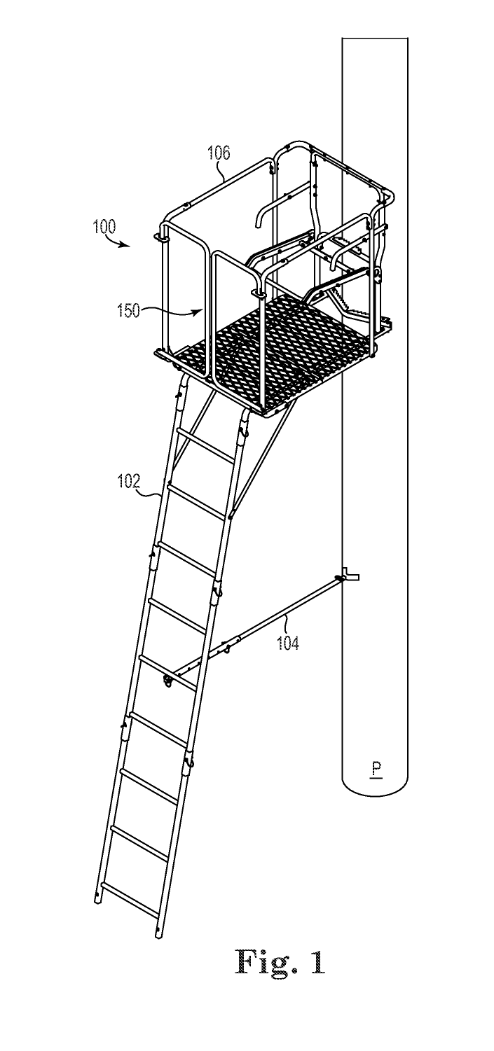

FIG. 1 illustrates an exemplary hunting stand 100 installed on a support post P, such as for example, a tree, in accordance with an embodiment of the present disclosure. The hunting stand 100 includes a ladder assembly 102, a support brace 104 and a platform assembly 106. Ladder assembly 102 supports platform assembly 106 and provides a mechanism for a hunter to ascend and descend hunting stand 100. Support brace 104 provides additional support for ladder assembly 102. Hunting stand 100 can be constructed of any suitable materials capable of bearing weight and withstanding the weather elements, such as for example, powder-coated all-weather steel, aluminum, fiber reinforced thermoset resins, natural or engineered wood products, carbon fiber, composite materials, and/or combinations thereof.

Components of hunting stand 100 are connected using fasteners, such as bolts or rivets, or welded connections. Hunting stand 100 can optionally be camouflaged and/or covered by a blind to conceal a hunter's presence. Hunting stand 100 materials can be camouflaged using a powder coating technique, water emersion printing, thin film coating, color fusion, or another suitable technique.

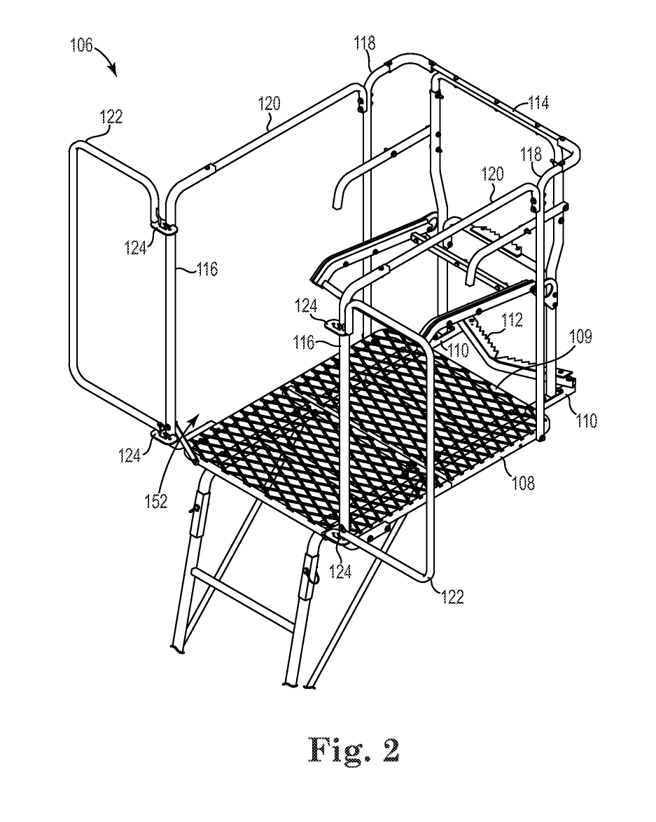

FIG. 2 illustrates an exemplary platform assembly 106. Platform assembly 106 includes a platform portion 108, rear posts 110, tree engagement piece 112, a seat assembly 114 front uprights 116, rear uprights 118, horizontal support members 120, enclosure gates 122, and hinge brackets 124.

Platform portion 108 is connected to ladder assembly 102 and is preferably constructed of a rigid material adapted to support the weight of one or more hunters, such as steel or aluminum mesh welded on top of steel or aluminum tubing. Platform portion 108 can also be constructed out of cast metals or alloys, such as cast aluminum. Platform portion 108 provides a shooting platform for a hunter in a standing position and a foot rest for a hunter in a seated position.

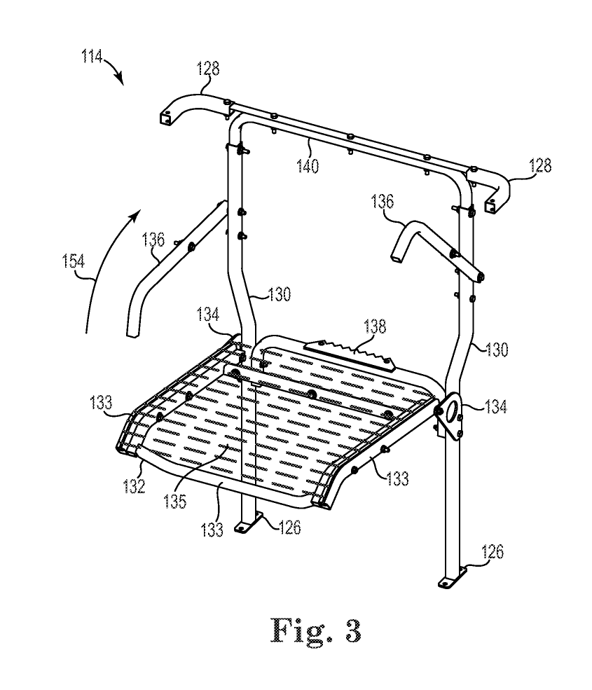

Platform portion 108 also includes rear posts 110. Tree engagement piece 112 and seat assembly 114 are connected to rear posts 110. Tree engagement piece 112 includes a rigid serrated edge for “biting” into a tree or wooden post. Rear posts 110 can be positioned at various positions along the width of platform 108 thereby allowing seat assembly 114 to be of a different width than platform portion 108. In the exemplary embodiment shown in FIG. 2 the width of the seat assembly 114 is approximately two-thirds the width of the platform portion 108. Seat assembly 114 is described in greater detail in accordance with FIG. 3.

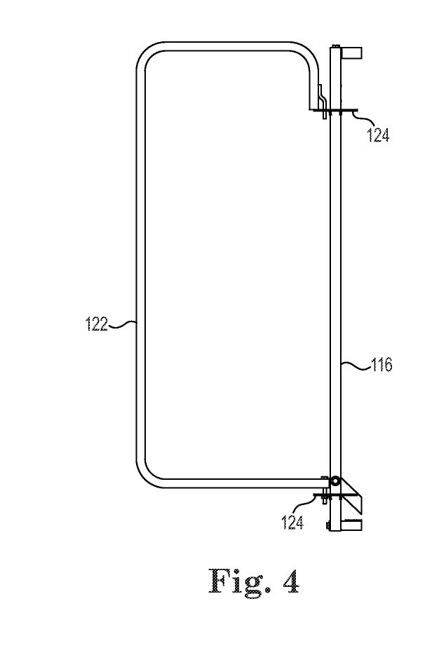

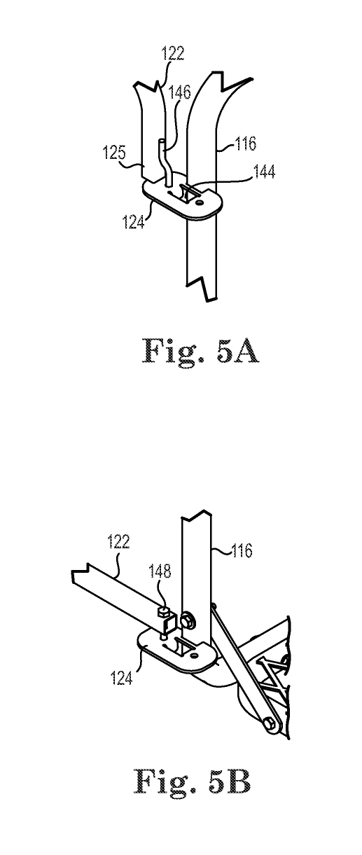

Front uprights 116 and rear uprights 118 are constructed of like material as platform portion 108 and connected to platform portion 108 as shown in FIG. 2. Horizontal support members 120 are connected to front upright 116 at a first end and to rear upright 118 at a second end. Enclosure gates 122 are connected to front uprights 116 using brackets 124. Enclosure gates 122 are described in greater detail in accordance with FIGS. 4-5B. Together front uprights 116, horizontal support members 120, rear uprights 118, and enclosure gates 122 form an enclosure for a hunter. Enclosure provides a shooting rail for a hunter and provides a structure for attaching a blind (not shown) thereby concealing a hunter's presence and protecting a hunter from the elements. Seat assembly 114 is attached to enclosure at rear uprights 118 and rear posts 110.

FIG. 3 illustrates an exemplary seat assembly 114. Seat assembly 114 is secured to the platform assembly 108 using base mounting plates 126. Seat assembly 114 is secured to rear uprights 118 using ninety degree connectors 128. Base mounting plates 126 are connected to seat assembly uprights 130. Folding seat platform 132 is connected to seat assembly uprights 130 via seat brackets 134 in a manner such that seat platform 132 can rotate ninety degrees in direction 154 to an upright position thereby allowing a hunter stand at the rear edge 109 of the platform portion 108 when the seat platform 132 is in the upright position.

Seat platform 132 is generally rectangular in shape and adapted to allow a hunter to sit comfortable for an extended period of time. Seat platform 132 can be sized to support one or more hunters. In the exemplary embodiment seat platform 132 is sized to support one hunter and has a width of approximately two-thirds of platform portion 108 width. The relative widths of the seat platform 132 and platform portion 108 provide a hunter ample seating space while providing ample standing space.

The seat platform 132 includes frame members 133 and support material 135, such as for example, cables, nylon straps, fabric, and the like. Seat platform 132 can be constructed of a rigid material, such as a steel or aluminum mesh or plastic, and include a support cushion constructed of a suitable foam material to provide comfort and insulation. In the exemplary embodiment, weight bearing fabric 135, such a canvas or a synthetic weaved mesh fabric, spans the width of seat platform 132.

Arm rests 136 are optionally connected to seat assembly uprights 130 in a manner such that seat platform 132 can rotate in direction 154 ninety degrees from a downward position to an upright position thereby providing arm support when a hunter is in a seated position and being movable out of the way when a hunter standing at the rear of platform portion 108. Arm rests 136 can be supported using cables or nylon straps (not shown). It is important to note that the configuration of the seat assembly 114 allows each arm rest 136 and seat platform 132 to be placed in respective upward and downward positions independently. Hunting stand 100 can include multiple seat assemblies to allow multiple hunters to hunt from platform 108.

Tree engagement piece 138 and upper seat assembly support 140 are also connected to seat assembly uprights 130. Similar to tree engagement piece 112 described above tree engagement piece 138 includes a rigid serrated edge for “biting” into a tree or wooden post. Together seat assembly uprights 130, tree engagement piece 138 and upper seat assembly support 140 form seat back support. Similar to seat platform 108, in the exemplary embodiment weight bearing fabric (not shown), such a canvas or a synthetic weaved mesh fabric, spans the area of the seat back support.

FIG. 4-5B illustrate the operation of enclosure gates 122. As described in accordance with FIG. 1, enclosure gates 122 are connected to front uprights 116 using hinge brackets 124. In the exemplary embodiment, hinge brackets 124 are welded to front uprights 116.

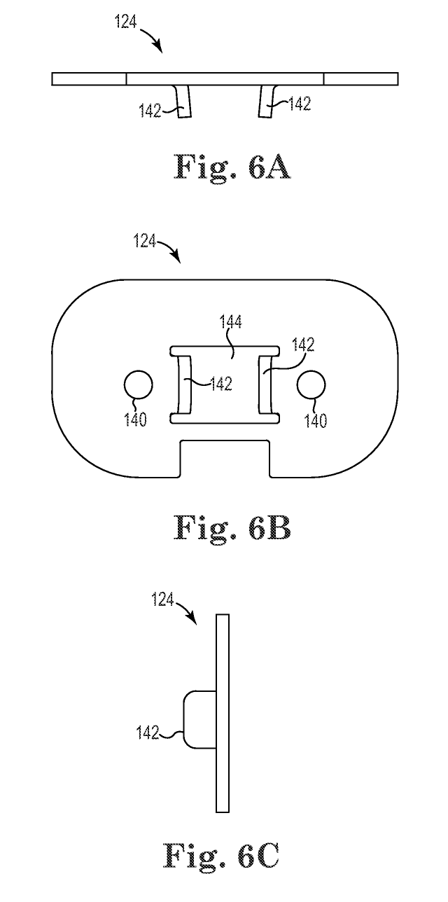

Hinge brackets 124 are shown in greater detail in FIGS. 6A-6C. Hinge brackets 124 include holes 140 for receiving an enclosure gate 122 connector. Hinge brackets 124 include tabs 142 bent downward to form enclosure gate receiving hole 144. As illustrated in FIG. 5A a connector pin 146 is welded to a face of top end of enclosure gate 122. Connector pin 146 fits into hole 140, thereby securing top of enclosure gate 122 to hinge bracket 124 while allowing enclosure gate 122 to rotate generally horizontally from open position 152 as shown in FIG. 2 to closed position 150 as shown in FIG. 1. As illustrated in FIG. 5B, bolt 148 goes through a top face of enclosure gate 122 and fits into hole 140, thereby securing bottom of enclosure gate 122 to hinge bracket 124 while allowing enclosure gate 122 to rotate from open position as shown in FIG. 2 to a closed position as shown in FIG. 1.

When enclosure gate 122 is in a closed position, the top end 125 of enclosure gate 122 drops into enclosure gate receiving hole 144. The engagement of 125 in the hold 144 locks enclosure gate 122 in the closed position 150. This locking mechanism provides additional security for a hunter on platform 108. To open, the user lifts the enclosure gate 122 to remove top end 125 from the receiving hole 144, and rotates the enclosure gate 122 generally horizontally to the open position 152. A user can lift and rotate enclosure gate 122 either while standing on platform 108 or while standing on ladder assembly 102.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges which may independently be included in the smaller ranges is also encompassed within the disclosure, subject to any specifically excluded limit in the stated range. Where the stated range includes one or both of the limits, ranges excluding either both of those included limits are also included in the disclosure.

Unless defined otherwise, all technical and scientific terms used herein have the same meaning as commonly understood by one of ordinary skill in the art to which this disclosure belong. Although any methods and materials similar or equivalent to those described herein can also be used in the practice or testing of the disclosure, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present disclosure are not entitled to antedate such publication by virtue of prior invention. Further, the dates of publication provided may be different from the actual publication dates which may need to be independently confirmed.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed is:

1. An elevated hunting stand, comprising:
a ladder assembly;
a platform operably connected to the ladder assembly;
a pair of first vertical uprights connected to the platform at a front portion of the platform;
a pair of second vertical uprights connected to the platform at a rear portion of the platform;
a first horizontal stabilizer member attached at a proximal end to one of the first vertical uprights and attached at a distal end to one of the second vertical uprights;
a second horizontal stabilizer member attached at a proximal end to one of the first vertical uprights and attached at a distal end to one of the second vertical uprights; and
a pair of enclosure gates pivotally attached to respective one of the pair of first vertical uprights to rotate generally horizontally between an open position to an closed position, such that the pair of first vertical uprights, the pair of second vertical uprights, the first horizontal stabilizer member, the second horizontal stabilizer member, and the pair of enclosure gates form an enclosure on the platform wherein each of the enclosure gates are movable between an open position and a closed position.

2. The elevated hunting stand of claim 1, further comprising:
a seat assembly including a seat platform, a first arm rest and a second arm rest, wherein the seat platform, the first arm rest and the second arm rest are independently rotatable from a horizontal position to a vertical position.

3. The elevated hunting stand of claim 2, wherein the seat platform comprises a synthetic weaved mesh fabric.

4. The elevated hunting stand of claim 2, wherein the seat assembly includes a pair of uprights wherein each upright includes a seat platform bracket connected to the seat platform.

5. The elevated hunting stand of claim 1, further comprising at least one enclosure bracket connected to each of the first vertical uprights wherein the at least one bracket is configured to allow the enclosure gates to be locked in the closed position.

6. The elevated hunting stand of claims 5, further comprising a seat assembly including a seat platform, a first arm rest and a second arm rest, wherein the seat platform, the first arm rest and the second arm rest are independently rotatable from a horizontal position to a vertical position.

7. The elevated hunting stand of claim 1, the enclosure gates are locked in the closed position and are movable from a locked position to an unlocked position by lifting on the enclosure gates.

8. An elevated hunting stand, comprising:
a ladder assembly;
a platform operably connected to the ladder assembly; and
a seat assembly connected to the platform including a seat platform, a first arm rest and a second arm rest, wherein the seat platform, the first arm rest and the second arm rest are independently rotatable from a horizontal position to a vertical position.

9. The elevated hunting stand of claim 8, wherein seat platform comprises a synthetic weaved mesh fabric.

10. The elevated hunting stand of claim 9, wherein seat assembly includes a pair of uprights wherein each upright includes a seat platform bracket connected to the seat platform.

11. The elevated hunting stand of claim 8, wherein the width of the seat assembly is approximately two-thirds the width of the platform.

12. The elevated hunting stand of claim 8, further comprising a pair of enclosure gates wherein the enclosure gates form an enclosure on the platform wherein each of the enclosure gates are movable from an open position to a closed position.

13. The elevated hunting stand of claim 12, wherein the enclosure gates are configured to be locked in the closed position and are movable from a locked position to an unlocked position by lifting on the enclosure gates.

14. The elevated hunting stand of claim 13, further comprising at least one enclosure bracket configured to allow the enclosure gates to be locked in the closed position.

15. A method of assembling an elevated hunting stand comprising the steps of:
connecting a platform to a ladder assembly;
connecting a pair of first vertical uprights to a front portion of the platform;
connecting a pair of enclosure gates to respective one of the pair of first vertical uprights, such that each of the enclosure gates are movable generally horizontally from an open position to a closed position.

16. The method of claim 15, wherein connecting a pair of enclosure gates to respective one of the pair of first vertical uprights further includes connecting the enclosure gates such that the enclosure gates are configured to be locked in the closed position.

17. The method of claim 16, wherein connecting a pair of enclosure gates to respective one of the pair of first vertical uprights further includes connecting the enclosure gates via an enclosure gate bracket.

18. The method of claim 17, wherein connecting a pair of enclosure gates to respective one of the pair of first vertical uprights further includes connecting the enclosure gates such that the enclosure gates are movable from a locked position to an unlocked position by lifting on the enclosure gates.

19. The method of claim 18, further comprising the step of:
connecting a seat assembly including a seat platform, a first arm rest and a second arm rest, to the platform wherein the seat platform, the first arm rest and the second arm rest are independently rotatable from a horizontal position to a vertical position.

20. The method of claim 19, wherein connecting a seat assembly including a seat platform, a first arm rest and a second arm rest, to the platform wherein the seat platform, the first arm rest and the second arm rest are independently rotatable from a horizontal position to a vertical position includes providing a seat platform composed of synthetic weaved mesh fabric.
